(19) United States
(12) Patent Application Publication
(10) Pub. No.: US 2020/0106141 A1
(43) Pub. Date: Apr. 2, 2020

(54) BATTERIES AND METHODS FOR HANDLING A DETECTED FAULT CONDITION

(71) Applicant: Motorola Solutions, Inc., Chicago, IL (US)

(72) Inventors: Scott J. Arendell, Buford, GA (US); Roy L. Kerfoot, JR., Lilburn, GA (US); Mark C. Taraboulos, Dunwoody, GA (US); Donald L. Flowers, Dacula, GA (US); John E. Herrmann, Suwanee, GA (US)

(21) Appl. No.: 16/149,762

(22) Filed: Oct. 2, 2018

(51) Int. Cl. H01M 10/48; H01M 10/04; G06F 1/28

(52) U.S. Cl. CPC H01M 10/486; G06F 1/28; H01M 10/0445

(57) ABSTRACT

In accordance with some embodiments, a battery includes a cell and a thermistor coupled to a monitor line and a switch. The monitor line is operable to send signals to the communications device or battery corresponding to a temperature of at least a portion of the battery. A data line is coupled to a decoder. The decoder is coupled to the switch, wherein the decoder is operable to activate the switch, thereby interrupting the thermistor. In accordance with some embodiments, a method includes receiving a fault signal at a data line of the battery, the fault signal indicating that at least a first cell of the communications device battery has been compromised. The method includes interrupting a thermistor by activating a switch coupled to a decoder coupled to the data line, thereby simulating that the temperature of at least a portion of the battery has reached an outer limit.

### BACKGROUND OF THE INVENTION

Batteries can have a single cell or multiple cells and can be arranged in parallel or in series. Batteries can power devices, such as portable communication devices. Each cell in a battery may receive electric current from a power supply or may deliver current to a device the battery is powering. In a fault condition in a battery, one or more cells are not being charged by a power supply at their normal rate or are not powering a device at their normal rate. A fault condition can occur, for example, due to damaged cells, failed weld connections, overheating, and other circumstances. When a fault condition occurs, and the battery is connected to be charged by a power supply, the current to a cell or cells and the charge rate can increase beyond normal limits. Such an increase can prevent the battery from operating reliably or safely.

### SUMMARY

To prevent or reduce the undesirable safety and reliability issues that occur when a fault condition occurs in a battery, disclosed herein are methods, batteries, and communication devices that can handle the fault condition. The methods, batteries, and communication devices can prevent a battery cell or cells from charging above a desired rate by disabling charging upon receiving a fault signal that indicates a fault condition has occurred.

In accordance with some embodiments, a battery is user-removable, meaning that the battery can be removed from a device or power supply and reattached. User-removable batteries may include parts operable to mate with corresponding parts on a power supply or a device. The battery can handle a detected fault condition by simulating that the battery has reached an outer temperature limit. A device or power supply connected to the battery can thereby treat the battery as if it is overcooled or overheated and disable charging.

In accordance with some embodiments, a battery includes a first cell and a thermistor coupled to a monitor line and a switch. The monitor line is operable to send signals to the device or the battery. The signals correspond to a temperature of at least a portion of the battery. To receive a fault signal, a data line is coupled to a decoder. The decoder is coupled to the switch, wherein the decoder, upon receiving a fault signal, is operable to activate the switch, thereby interrupting the thermistor. Since the inferred temperature of the battery varies with the impedance of the thermistor, interrupting the thermistor simulates that the temperature of at least a portion of the battery has reached an outer limit.

In accordance with some embodiments, a battery can flag itself as faulty upon receiving a fault signal. The battery includes a decoder that is coupled to a second switch. The decoder can activate the second switch, thereby writing to a latch, allowing the battery to flag itself as faulty.

In accordance with some embodiments, a battery may include a local memory. The local memory allows the battery to store information about itself and whether a fault signal was received and what kind of fault signal was received. The local memory can be useful for diagnosing why a fault condition occurred or in determining how to handle the fault condition received. The local memory is operable to store a value indicating that a fault signal has been received.

In accordance with some embodiments, a battery includes a switch for receiving a signal from a decoder and interrupting a thermistor to simulate a temperature. The switch includes a first terminal, a second terminal, and a third terminal. The decoder is coupled to the switch at the first terminal. The second terminal is coupled to the thermistor and the monitor line. The third terminal is grounded. The switch is thereby operable, by receiving a signal from the data line at the first terminal, to short the thermistor by creating a conductive path between the second terminal and the third terminal. In accordance with some embodiments, the thermistor is coupled in series with the second terminal, the third terminal, and the monitor line. The switch is thereby operable, by receiving a signal from the data line at the first terminal, to open the thermistor by disconnecting a conductive path between the second terminal and the third terminal.

In accordance with some embodiments, the data line is at least one of a one-wire communication line and an Inter-Integrated Circuit (I²C) bus. In accordance with some embodiments, a second cell is connected in series with a first cell. In accordance with some embodiments, a second cell is connected in parallel with a first cell.

Disclosed herein are methods of handling a detected fault condition in a battery. In accordance with some embodiments, a method can allow a device, power supply, or both to disable charging to prevent a cell or cells in the battery from charging beyond a desired rate.

In accordance with some embodiments, a method includes receiving a fault signal at a data line of a communications device battery. The fault signal indicates that at least a first cell of the communications device battery has been compromised. In accordance with some embodiments, a method includes interrupting a thermistor by activating a switch coupled to a decoder coupled to the data line, thereby simulating that the temperature of at least a portion of the battery has reached an outer limit.

In accordance with some embodiments, interrupting the thermistor includes shorting the thermistor. In accordance with some embodiments, interrupting the thermistor includes opening the thermistor.

It may be desired to continue discharge of a battery when the battery is connected to a device, even though the battery has received a fault condition. In accordance with some embodiments, a method includes allowing a battery to power a communications device.

It may be desired to prevent the battery from charging or discharging when the battery is later connected to a power supply or a device. In accordance with some embodiments, a method includes receiving a fault signal at a data line of the battery. The fault signal indicates that at least a first cell of the communications device battery has been compromised. In accordance with some embodiments, a method includes flagging that a fault signal has been received. In accordance with some embodiments, the flagging that the fault signal has been received includes writing to a latch. In accordance with some embodiments, the flagging that the fault signal has been received further includes activating a switch. The latch allows the flagging to be hardware-implemented and is robust. In accordance with some embodiments, the flagging that the fault signal has been received includes storing a value in a local memory on the communications device battery. The local memory may store additional information about the fault signal or why a fault signal was received.

So that a device or power supply can disable charging if desired, in accordance with some embodiments, a method includes sending a signal on a monitor line indicating that the thermistor has been interrupted.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of battery for handling a detected fault condition.

FIG. 2 is a flow chart of a method of handling a detected fault condition in a battery.

FIG. 3 is a communication system diagram for handling a detected fault condition.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Batteries disclosed herein can be used to power devices and can be charged by power supplies. Unless indicated otherwise, a “device” can be any item that a battery can power, a “power supply” is anything that can charge a battery, and a “battery” is an object that can retain an electric charge and can include one or more cells and circuitry. A battery may be contained in a user-removable battery for a communications device. A “communications device” may include a cellular telephone, radio, walkie-talkie, or other device used to send and/or receive electronic communications. First responders may desire user-removable batteries so that a battery can be replaced when it is depleted.

When a battery is plugged into a power supply for charging, preventing each of the cells of the battery from charging beyond a desired rate can increase safety and reliability of the battery. For example, the desired rate may be 1 C, the rate it takes to charge the battery in 1 hour. Sometimes the battery may enter a fault condition, meaning that the battery is damaged due to, for example, failed weld conditions, damaged cells, etc. A fault condition may also occur in a drop or shock event, a vibration event, a cell swell event, other “health” related events, or a combination thereof. The fault condition may be detected by a power supply or other device, or internal circuitry or a microprocessor in the battery. In a fault condition, a damaged cell may take on less, more, or no current. In a multiple-cell battery, the remaining cells of the battery may then take on additional current and may be charged at a rate exceeding the desired rate. If a single-cell battery is damaged, the single cell may also take on current and may charge at a rate exceeding the desired rate. Accordingly, power management is desired to prevent charging of a battery that has a fault condition to prevent the damaged cell or other cells from exceeding charging at a desired rate.

One way of using power management to prevent charging is by simulating to other systems that the temperature of the battery has reached an outer limit. For example, an associated power supply may have software-implemented or hardware-implemented configurations for preventing charging upon reading that the temperature of the battery has reached an outer limit. Additionally or alternatively, the battery itself may have software-implemented or hardware-implemented configurations for preventing charging upon reading that the temperature of the battery has reached an outer limit. Therefore, simulating that a temperature of the battery has reached an outer limit after receiving a fault condition can prevent the battery from charging, and therefore can prevent the cells from charging beyond a desired rate.

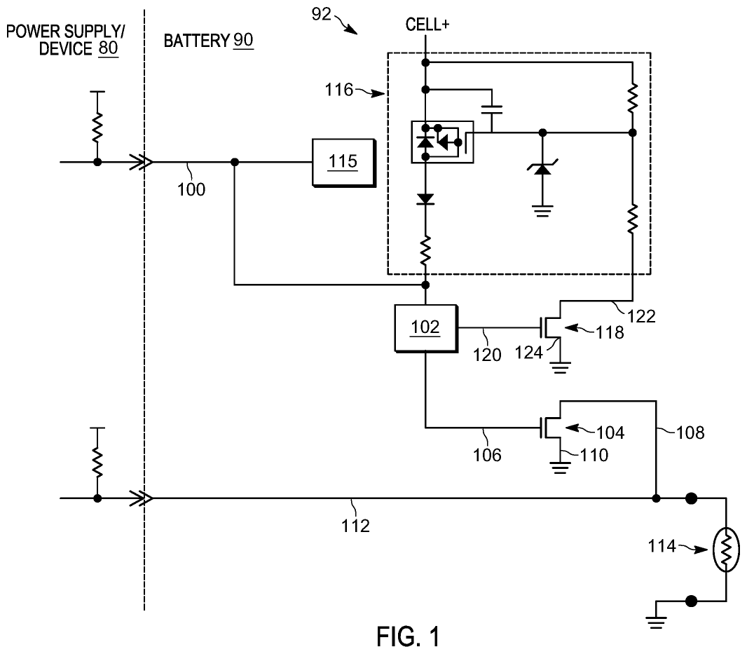

FIG. 1 shows, in accordance with some embodiments, a battery 90 with a battery circuit 92 for preventing the battery 90 from charging. The battery 90 allows for advantageous power management as will be described further in this disclosure. The battery 90 has a data line 100. The data line 100 is operable to transport signals to and from the battery 90 and to and from a power supply 80 or other device to which the battery 90 is coupled. The data line 100 may be any sort of communication line, for example, a one-wire communication line or an Inter-Integrated Circuit (I²C) bus. The data line 100 can receive a fault signal that indicates a fault condition has occurred. The fault signal indicates that at least a first cell in the battery 90 has been compromised which means that a fault condition has occurred or has been detected. The fault signal can contain additional information, such as the type of fault that has occurred. The additional information can include, for example, temperature information, identification of which cell or cells are damaged, and so on. To interpret the signal on the data line 100, the decoder 102 reads signals, including the fault signal, on the data line 100. The fault condition can be detected by the power supply 80 or other device, or the battery 90, or a combination thereof.

Upon receiving, at the data line 100, that a fault condition has occurred, the decoder 102 can activate a switch 104. The switch 104 is included to activate upon receiving a command from the decoder 102. The switch 104 has a first terminal 106, a second terminal 108, and a third terminal 110. When receiving a fault signal from the power supply 80 or device, the decoder 102 will send a signal to the first terminal 106, thereby activating the switch 104. The second terminal 108 is coupled to a monitor line 112 and a thermistor 114.

The monitor line 112 is operable to transport a signal that varies with temperature to the power supply 80 or device, whichever the battery 90 is connected to. Because the impedance of a thermistor 114 varies with temperature, the signal read by the monitor line 112 will also vary with temperature. Therefore, the power supply 80 or device will infer a temperature of the battery 90 according to the signal at the monitor line 112. When the switch 104 is activated, the thermistor 114 is interrupted. The thermistor 114 is shorted because the switch 104 upon activation creates a conductive path between the second terminal 108 and the third terminal 110 which is coupled to ground. The signal sent on the monitor line 112 will be similar to or the same as if the thermistor was hot. A power supply 80 or device coupled to the monitor line 112 will therefore read the signal and infer that the thermistor 114, and therefore the battery 90, is hot. Accordingly, the power supply 80 or device, through software, hardware, or a combination thereof, can disable or prevent the battery 90 from charging in the same manner as it would if the battery 90 was hot.

By varying the signal on the monitor line 112, the battery 90 in FIG. 1, in accordance with some embodiments, is operable to simulate a temperature, thereby “tricking” the power supply 80 or device to handle the faulted battery 90 as if the temperature of the battery 90 reached certain outer limits. The battery 90 therefore handles a detected fault condition by enabling the power supply 80 or device to treat the battery 90 as if it were hot, thereby preventing or disabling charging. The outer limits could be a set temperature based on interpreting the current, voltage, impedance, etc., of the thermistor 114. The outer limits may include a minimum limit (a temperature which the battery 90 is not to fall below) and a maximum limit (a temperature which the battery 90 is not to rise above). A battery reaches an outer limit when the temperature meets or goes below a minimum limit or meets or goes above a maximum limit.

Additionally, the battery 90 can “flag” itself as faulty to prevent charging when the battery 90 is later disconnected from the power supply 80 or device and thereafter connected to a different or the same power supply 80 or other device. One way the battery 90 flags itself as faulty is by receiving at a local memory 115 a fault signal on the data line 100. The local memory 115 can then store a value that indicates it has received a fault signal and can include information about the fault signal or why the fault signal was received (e.g., which cell was compromised, the type of problem occurring, the temperature reached). When the local memory 115 is written to, the battery 90 can be disconnected from the power supply 80 or the device and retain information. When the battery 90 is later connected to another or the same power supply 80 or device, that power supply or device can read from the local memory 115 that a fault signal has previously been received. The power supply or the device can then activate switch 104 (by, for example, sending another fault signal) and simulate a temperature. Such a simulation, as described above, can disable or prevent charging. The local memory 115 may be the primary memory of the battery 90 and may store any information.

The local memory 115 may be part of any scalable device that can store data, receive data, make decisions, provide data, or a combination thereof. For example, the local memory 115 can be part of a microprocessor on the battery 90. Such a microprocessor may receive input from the data line 100, for example, and send output along the data line 100. A microprocessor could detect a fault condition alone, or in conjunction with the power supply 80 or other device. The local memory 115 can be any sort of electronic memory, such as semiconductor memory.

Another way the battery 90 is flagged as faulty is by using a latch 116. Upon receiving, at the data line 100, that a fault condition has occurred, the decoder 102 can activate a switch 118. The switch 118 has a first terminal 120, a second terminal 122, and a third terminal 124. When receiving a fault signal, the decoder 102 will send a signal to the first terminal 120, thereby activating the switch 118. When the switch 118 is activated to be on, current will flow through the switch 118, writing a high value to the latch 116. The high value stored in the latch 116 indicates that the battery 90 has received a fault signal and is faulty (compromised). When the latch 116 is written to (stores a high value), the battery 90 can be disconnected from the power supply 80 or the device and retain its high value. When the battery 90 is later connected to another or the same power supply 80 or device, the latch 116 will pull high the input into the decoder 102, thereby driving switch 104, interrupting the thermistor 114, and thereby simulating a temperature. Such a simulation, as described above, can prevent or disable charging. The latch 116 can be implemented in any number of ways to store a high or low value upon receiving current based on the decoder 102 output.

The battery 90 may flag itself in either or both manners described above. Each manner has its advantages. It may be desired to flag the battery 90 in the local memory 115 because flagging in this way can store detailed information about the fault signal or why the fault signal was received (e.g., which cell was compromised, the type of problem occurring, the temperature reached). It may be desired to flag the battery 90 in the latch 116 because flagging in this way is robust and hardware-implemented, and does not need to rely on, for example, two-way communication with the local memory 115. Therefore, the battery 90 can receive the fault signal and flag itself as faulty in the local memory 115, the latch 116, or both. Flagging the battery 90 in both manners allows for both advantages: detailedness from flagging in the local memory 115 and robustness from flagging in the latch 116. The battery 90 may store a value in the latch, for example, a single bit, or a single high or “1,” or a single low or “0.” The battery 90 may store a value in the local memory 115, for example, a plurality of bits (1's and/or 0's) containing detailed information about the fault signal or why the fault signal was received.

As described above, the battery 90 may flag itself. The software or hardware configuration of the connected power supply 80 or device determines how to handle a battery that has been flagged or has reached an outer temperature limit, so the battery 90 can continue to discharge to or receive charge from the power supply 80 or device, respectively. Depending on a device or power supply configuration, or additionally or alternatively a battery configuration, the battery 90 can also be prevented from discharging. While it may be desirable to prevent charging of the battery 90 by a power supply in a fault condition, it may be desired to allow a device (e.g., communications device) to be powered by the battery 90 in a fault condition or, in other words, to allow the battery 90 to discharge. A user of a device, for example, a first responder using a communications device, may need to use the device for the remainder of the charge left in the battery 90, even when a fault condition is detected. The user may need time to replace or repair the battery 90 when the battery 90 is faulty. Accordingly, a device, in response to a fault signal, may be configured to not prevent discharge of the battery 90 upon reading on the monitor line 112 that a temperature has reached an outer limit. Such a device allows at least the non-damaged cell or cells (additionally or alternatively, the damaged cell or cells) to power the device.

Additionally or alternatively, the decoder 102 can be configured to activate the switches 104 and 118 upon any desired condition. The battery 90 therefore can be configured to flag itself, interrupt the thermistor, both, or none, upon any desired condition. For example, the decoder can be configured to activate switch 104 only when the battery 90 is connected to a device and the decoder has received a fault signal.

Although FIG. 1 illustrates that the second terminal 108 is coupled to the thermistor 114 and the third terminal 110 is grounded, the battery 90 can be configured in a number of ways to interrupt the thermistor 114 to simulate that the temperature of at least a portion of the battery 90 has reached an outer limit. For example, the thermistor 114 can be coupled in series with the second terminal 108, the third terminal 110, and the monitor line 112. Switch 104 would by default be closed, thereby creating a conductive path from the second terminal 108, through the thermistor 114, and through the third terminal 110. When the switch 104 is activated in this configuration, the switch 104 opens the thermistor, disconnecting the conductive path between the second terminal 108 and the third terminal 110. The power supply 80 or device will read a low or no signal on the monitor line 112 and infer that at least a portion of the battery 90 is cold and has reached an outer limit. The battery 90 therefore handles a detected fault condition by enabling the power supply 80 or device to treat the battery 90 as if it were cold and thereby prevents charging. A fuse could also be used in place of or in addition to a thermistor, receiving a signal from the switch 104 and blowing when the battery 90 has reached an outer limit.

Although the battery 90 is shown using two switches 104 and 118, the battery 90 can be configured for use with a single switch. The single switch would interrupt the thermistor 114 and flag the battery 90 as faulty in latch 116, whenever the decoder activated the single switch.

The battery 90 in FIG. 1 may be configured in any number of ways. For example, the battery circuit 92 shown in FIG. 1 includes all elements 100 through 124. But some elements may be removed, other elements may be added, or a combination thereof. As an example, the latch 116 may be removed. The decoder 102 may be powered by the power supply 80 or other device. The decoder 102 may be powered by the power supply 80 or other device through the data line 100. The decoder 102 may be powered by cells of the battery 90. Any decision or monitoring described above as performed for the power supply 80 or other device may be done by the battery 90. For example, the battery 90 may detect a fault condition, handle or determine how to handle a fault condition, or a combination thereof. The battery 90 itself can prevent or disable charging. As another example, the battery can “trick” itself (rather or in addition to “tricking” the power supply 80 or other device) into handling a fault as if the temperature of the battery 90 had reached outer limits. Such decisions may be stored by the local memory 115, may be performed by a microprocessor, or other logical device that includes the local memory 115, or a combination thereof. Additionally or alternatively, such decisions may be performed in whole or in part by a microprocessor or other logical device that includes no memory.

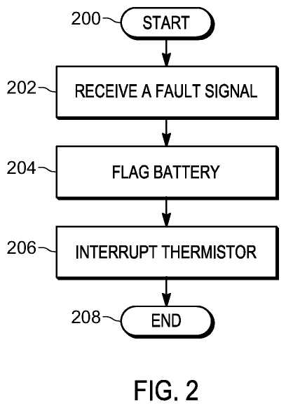

FIG. 2 depicts a method of handling a detected fault condition in a battery in accordance with some embodiments. The method provides power management and may be used in accordance with any of the batteries described above. The battery may be part of a communications device, a user-removable battery, or both.

The method starts at step 200. To condition preventing or disabling charging upon a fault condition, the method includes receiving a fault signal on a data line at step 202. The fault signal may indicate that at least a first cell of the battery has been compromised and is in a fault condition. The signal can be received by a decoder coupled to the data line.

To prevent or disable the battery from charging after being reconnected to a device or power supply, the method includes flagging the battery as faulty at step 204. Step 204 may include storing a value in a local memory on the battery. The value stored in local memory represents that a fault signal has been received. The value may also represent information about the fault signal or why the fault signal was received. Step 204 may include activating a second switch to write to a latch or otherwise writing to a latch. The latch may store a single high value and may operate to pull high an input into the switch that is coupled to the thermistor. To allow the method to both store detailed information and be robust, step 204 may include both storing a value in a local memory on the battery and writing to a latch.

It may be desired to continue allowing the battery to discharge to power a device or continue charging from a power supply. Accordingly, step 204 does not necessarily include disabling charging or discharging, allowing, for example, a cell in the battery to power the device. The cell may be a first, second, third, fourth, etc., cell of the battery.

To simulate that the temperature of at least a portion of the battery has reached an outer limit, the method includes interrupting a thermistor at step 206. Simulating that the temperature of at least a portion of the battery has reached an outer limit will enable the device or power supply to prevent or disable charging. Step 206 includes activating a switch coupled to the decoder. The decoder is coupled to the data line. By interrupting the thermistor, the method simulates that the temperature of at least a portion of the battery has reached an outer limit. Such a simulation may ultimately cause the power supply to stop charging the battery. The thermistor may be interrupted by shorting the thermistor, simulating that the thermistor is hot and has reached an upper outer limit of temperature. The thermistor may be interrupted by opening the thermistor, simulating that the thermistor is cold and has reached a lower outer limit of temperature. The interrupting of the thermistor may include sending a signal on a monitor line indicating that the thermistor has been interrupted. A power supply or device, upon receiving the signal on the monitor line, will infer that the temperature of the thermistor and at least a portion of the battery has reached an outer limit. Accordingly, a power supply will be able to prevent or disable charging the battery. The method includes ending at step 208.

The steps of the above method can be rearranged and combined in any number of ways. For example, any step may be removed based on the configuration of the device or the power supply to which the battery is coupled. Any step may be removed based on whether the battery is connected to a device or a power supply. As a further example, the battery may be flagged as faulty only when connected to a device and when a fault signal is received. As another example, the thermistor may be interrupted only when connected to a power supply and a fault signal is received.

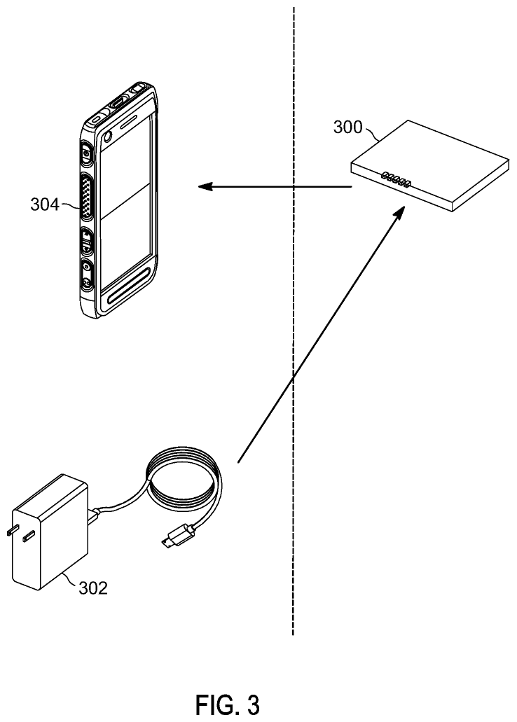

FIG. 3 shows a battery 300 in accordance with some embodiments. The battery 300 may be charged by the power supply 302 and may discharge to power the communications device 304. The battery 300 shown in FIG. 3 may include any portion or portions of the embodiments described elsewhere in this disclosure, for example, the embodiments described in reference to FIG. 1 and FIG. 2.

In accordance with some embodiments, if a fault condition is detected while the battery 300 is coupled to the power supply 302, the battery 300 may interrupt a thermistor within the battery 300 to simulate a fault condition. In accordance with some embodiments, if a fault condition is detected while the battery 300 is coupled to the communications device 304, the battery 300 may interrupt a thermistor within the battery 300 to simulate a fault condition. A fault condition may be detected by the battery 300, the power supply 302, the communications device 304, or a combination thereof.

In accordance with some embodiments, if a fault condition is detected while the battery 300 is coupled to the power supply 302, the battery 300 may flag itself as faulty. In accordance with some embodiments, if a fault condition is detected while the battery 300 is coupled to the communications device 304, the battery 300 may flag itself as faulty. In accordance with some embodiments, the battery 300 may be flagged as faulty in a local memory in the battery 300, a latch in the battery 300, or both. In accordance with some embodiments, if a fault condition is detected while the battery 300 is not coupled to the power supply 302 or the communications device 304, the battery 300 may flag itself as faulty.

In accordance with some embodiments, if the battery 300 is flagged, the power supply 302 may prevent or disable charging of the battery 300 when the power supply 302 is coupled to the battery 300. In accordance with some embodiments, if the battery 300 is flagged, the power supply 302 may allow itself to continue to charge the battery 300. In accordance with some embodiments, if the battery 300 is flagged, the communications device 304 may allow the battery 300 to continue to discharge into the communications device 304 to power the communications device 304. In accordance with some embodiments, if the battery 300 is flagged, the communications device 304 may prevent or disable the battery 300 from discharging into the communications device 304 to power the communications device 304. In accordance with some embodiments, if the battery 300 is flagged, the battery 300 may allow the battery 300 to continue to discharge into the communications device 304 to power the communications device 304. In accordance with some embodiments, if the battery 300 is flagged, the battery 300 may prevent or disable the battery 300 from discharging into the communications device 304 to power the communications device 304.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A battery comprising:
a first cell;
a thermistor coupled to a monitor line and a switch; and
a data line coupled to a decoder, the decoder coupled to the switch, wherein the decoder, upon receiving a fault signal, is operable to activate the switch, thereby interrupting the thermistor.

2. The battery of claim 1, further comprising a local memory, the local memory operable to store a value indicating that a fault signal has been received.

3. The battery of claim 1, wherein:
the decoder is coupled to a second switch; and
the decoder, upon receiving a fault signal, is operable to activate the second switch, thereby writing to a latch.

4. The battery of claim 1, wherein:
the switch comprises a first terminal, a second terminal, and a third terminal;
the decoder is coupled to the switch at the first terminal;
the second terminal is coupled to the thermistor and the monitor line; and
the third terminal is grounded, the switch thereby operable, by receiving a signal from the data line at the first terminal, to short the thermistor by creating a conductive path between the second terminal and the third terminal.

5. The battery of claim 1, wherein:
the switch comprises a first terminal, a second terminal, and a third terminal;
the decoder is coupled to the switch at the first terminal;
the decoder is coupled to the data line; and
the thermistor is coupled in series with the second terminal, the third terminal, and the monitor line, the switch thereby operable, by receiving a signal from the data line at the first terminal, to open the thermistor by disconnecting a conductive path between the second terminal and the third terminal.

6. The battery of claim 1, wherein the data line is a one-wire communication line.

7. The battery of claim 1, wherein the battery further comprises a second cell connected in series with the first cell.

8. The battery of claim 1, wherein the battery further comprises a second cell connected in parallel with the first cell.

9. A method of handling a detected fault condition in a communications device battery, the method comprising:
receiving a fault signal at a data line of the communications device battery, the fault signal indicating that at least a first cell of the communications device battery has been compromised; and
interrupting a thermistor by activating a switch coupled to a decoder coupled to the data line, thereby simulating that a temperature of at least a portion of the communications device battery has reached an outer limit.

10. The method of claim 9, further comprising allowing the communications device battery to power a communications device.

11. The method of claim 9, further comprising flagging that the fault signal has been received.

12. The method of claim 11, wherein the flagging that the fault signal has been received comprises writing to a latch.

13. The method of claim 9, further comprising sending a signal on a monitor line indicating that the thermistor has been interrupted.

14. The method of claim 9, wherein the interrupting the thermistor comprises shorting the thermistor.

15. The method of claim 9, wherein the interrupting the thermistor comprises opening the thermistor.

16. A method of handling a detected fault condition in a communications device battery, the method comprising:
receiving a fault signal at a data line of the communications device battery, the fault signal indicating that at least a first cell of the communications device battery has been compromised; and
flagging that a fault signal has been received by storing a value in the communications device battery.

17. The method of claim 16, further comprising allowing the communications device battery to power a communications device.

18. The method of claim 16, wherein the value is a single bit and the flagging that the fault signal has been received by storing the value in the communications device battery comprises writing the value to a latch.

19. The method of claim 18, wherein the flagging that the fault signal has been received by storing the value in the communications device battery comprises activating a switch.

20. The method of claim 16, wherein the value includes a plurality of bits and the flagging that the fault signal has been received by storing the value in the communications device battery comprises storing the value in a local memory on the communications device battery.
